(19) United States
(12) Patent Application Publication
(10) Pub. No.: US 2009/0313665 A1
(43) Pub. Date: Dec. 17, 2009

(54) DIGITAL RIGHTS MANAGEMENT LICENSING OVER THIRD PARTY NETWORKS

(75) Inventor: Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television Inc.

(21) Appl. No.: 12/140,591

(22) Filed: Jun. 17, 2008

(51) Int. Cl. H04N 7/173

(52) U.S. Cl. 725/93

(57) ABSTRACT

A user on a cable network can request and receive a digital license for viewing certain requested content provided to the user at a set top box on the cable network. The set top box generates a request for a license to the Cable Service Provider, which screens the request, and if allowed, ascertains a Content Provider for fulfilling the request. The cables services provider forwards the request to the Content Provider, and receives a response thereto, which includes a license for viewing the previously requested content. The cable services provided forwards the license to the set top box, which processes the license allowing the user to view the requested content. Both the Cable Service Provider and the Content Provider screen and analyze the request against various criteria and record the information for future processing.

### FIELD OF THE INVENTION

The present invention generally pertains to digital rights management by providing a license to a user, who typically is a viewer on a cable system, from a licensor which is the owner of a movie or other content, to be processed for viewing, wherein the user communicates the request for the license using a third party network (e.g., the Cable Service Provider).

### BACKGROUND OF THE INVENTION

Presently, content owners, e.g., owners of the copyright associated with content such as movies, routinely release digital content to third-party distributors or aggregators in unencrypted form. This poses a risk that the content may be illegally copied.

In the past, when content was distributed in physical form (e.g., such as a film), physical security was important to avoid illegal copies being made (e.g., ensuring that the content is only accessible by certain individuals). However, most content today is provided in digital form, and digital media can be often remotely accessed. Providing appropriate security via firewalls, passwords, and other communication-based security measures are not always effective or sufficient to prevent unauthorized access. Thus, encrypting the digital content is another level of security that is often relied upon to prevent unauthorized viewing when unauthorized copies are obtained.

Presently, the Content Provider may or may not provide the content to a distributor in encrypted form; this may depend on the contract terms between the content owners and the third party. Often, the Content Provider delivers the movies or content in unencrypted form to the distributor and relies on the distributor to encrypt the content when providing it to the viewer, this approach adds risk to the content owners, because digital content can be easily copied before encryption, and there is always a motivation by certain groups to obtain illegal copies in order to distribute “bootleg” copies of the content.

Thus, the Content Provider may provide the content to the distributor in an unencrypted form, and rely on the distributor to encrypt the content, and provide the decryption keys to authorized persons at the appropriate time (e.g., when the viewer who has paid or is otherwise legitimately entitled to view the movie). As mentioned, this does provide some risk to the content owner.

On the other hand, the content owner could encrypt the content and provide it to the distributor, but then the content owner must also provide the decryption keys to the distributor. Again, there is the possibility that the distribution keys could be compromised. The content owner must rely on the distributor to protect the content via the keys throughout the life cycle of the content.

From the perspective of the content owner, the desire to maintain security of the content (to prevent unauthorized copying) and the desire to make the content easily available to users for viewing, are competing desires. While one approach is for the Content Provider to rely on the distributor to control access and ensure only authorized users can view the content, this approach leaves the content owners somewhat at risk. However, if the Content Providers encrypt the content prior to distribution to the distributor, then this burdens the administration of the decryption keys. If the distributor is not able to effectively and efficiently manage the provision of keys to the viewers, the number of subscribers viewing the content may be not as great as it could be.

Presently, the distributors (e.g., cable operators) provide a service to their customers, which often includes providing access to pay-per-view movies and other digital content. This requires the viewer be a subscriber of the Cable Service Provider. The Cable Service Provider aggregates movie content, and makes the movies easily and timely available for the viewer to view. The Cable Service Provider also bills and services the customer as needed. In order to provide that service, the distributors process requests for content by viewers, verify their status (including credit status), and their rights to view the content (which may be based on a subscription level), and record the request in a billing system. The Cable Service Provider then periodically bills the subscriber for the service.

Similarly, the Content Providers typically have an arrangement with the Cable Service Providers to provide content, including recently available movies. The Content Providers charge and bill the Cable Service Providers, who in turn, as described above, charge and bill their subscribers. This provides a benefit as it avoids the Content Provider having to negotiate directly with the subscriber, and vice versa. Doing so would be time intensive, and result in higher transaction costs than the present arrangement.

However, the demand of cable service subscribers to view recently released movies has not been fully met. Content Providers are hesitant to release a valuable movie or content to cable providers, because the movie may be viewed on an unauthorized basis or otherwise copied. Once this occurs, the value of the content may be greatly diminished. In addition, a Content Provider typically only releases a movie to Cable Service Providers at a certain point in the life-cycle of the movie. Namely, movies are released to Cable Service Providers only when it other distribution avenues have been maximized, even though certain cable subscriber segments may be willing to pay a premium in order to view the movie sooner over a cable network. The Content Provider cannot control individual distribution at this level.

Thus, there exists a need for Content Providers to be able to provider greater control over the rights associated with viewing their content, but without incurring all the administrative costs associated with the greater control.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a network architecture for transmitting a request for a license from a Set Top Box to a Content Provider, and receiving a response thereto;

FIGS. 2 and 2a illustrate one embodiment of processing associated with a Set Top Box initiating a request for a license;

FIG. 3 illustrates one embodiment of a Cable Service Provider processing a request for a license;

FIG. 4 illustrates one embodiment of a Content Provider processing a licensing request;

FIG. 5 illustrates one embodiment of message formats for requesting, and responding to request, for a license processed by the Cable Service Provider.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

### Service Overview

In one embodiment, subscribers on a cable system are able to request tailored licenses from the content owner to view a particular digital asset. These licenses would be constructed to authorize only that particular subscriber's set top box (or viewing platform, which may comprise other devices) to view the requested content. Basically, only that set top box would be able to decrypt the content using the license key provided to the subscriber. The request is processed by the distributor (e.g., Cable Service Provider) and the existing business relationship between Cable Service Provider and the subscriber provides the context of the business transaction. The Cable Service Provider in turn sends a request to the appropriate Content Provider for a license, which is specific for that subscriber as defined by a subscriber profile (and associated with a set top box). The Content Provider is made aware of the Cable Service Provider making the request and the set top box originating the license request. The Content Provider responds to the request by either providing a license or a reason for denial. In this portion of communication between the Cable Service Provider and the Content Provider, the business relationship between the Content Provider and the Cable Service Provider is leveraged so that the Content Provider is not burdened with verifying the status and account details for each subscriber. Thus, in this manner the risk, costs, and benefits are somewhat spread out. Content owners would control access to their content by controlling the issuance of licenses, while Cable Service Providers would manage the viewer customer relationship, including credit checks and billing.

Both the Cable Service Provider and the Content Provider can screen the request. Thus, if an unauthorized user (set top box) is somehow detected, or if the subscriber initiating the license request represents an unworthy credit risk, the receiving entity can deny the request. Further, the license provided to decrypt the content may vary in the rights its grants. For example, a license can be granted for a single viewing, multiple viewing, or unlimited number of viewings, each of which are authorized within a defined time period. Based on the scope of the license granted, the subscriber may be charged differently by the Cable Service Provider, as would the Content Provider charge the Cable Service Provider.

Both the Cable Service Provider and the Content Provider can process the requests for licensing information and derive from this information, trends, and preferences of subscribers allowing each to market the same or similar content more effectively. For example, Cable Service Providers may use the type of requests made by a subscriber to select future forms of content which are likely to be of interest to the subscriber. Similarly, a Content Provider may use the information to market certain categories of assets to a particular Cable Service Provider.

### Architectural Overview

In the embodiment described herein, there are typically three main entities involved in fulfilling a digital rights management (“DRM”) License request. These are the: 1) Set Top Box (“STB”), 2) the Cable Service Provider (“CSP”), and 3) the Content Owner (a.k.a. “Licensor”). As will be demonstrated, other embodiments may involve other types of entities.

The STB is a device provided by the Cable Service Provider to its subscribers for receiving and decoding televisions signals for input by a television device. This is intended to encompass devices which are used in other video technology based signal distribution systems, such as satellite, mobile wireless, or fixed wireless systems. In other embodiments, the functions performed in the STB relative to the present invention may be incorporated in other types of devices connected to the cable network, such as cable ready modems, cell phones, or cable ready televisions sets. Thus, the present invention is not limited to conventional wireline (cable) STB.

Typically, one function provided by the STB is conditional access control, meaning that the STB provides the ability to descramble digital video signals (or in analog systems, descramble analog signals) when the user is authorized to view those channels. Conditional access is the mechanism that allows a service provider to control whether a user can view any, or a subset of, the channels provided over the cable network.

The STB also provides a mechanism for interacting with the user, and it is typically capable of providing graphical video windows or text information overlays, for purposes of providing information to the user. This capability is integrated with the remote control for receiving user input. Thus, the STB is capable of limited user interaction for obtaining information from the user regarding a request for a DRM license and indicating a DRM license has been obtained.

The STB is typically connected to a cable network, which has a tree structure, and at which the root of the tree is a cable headend. Typically, a Cable Service Provider may have more than one headend or multiple systems, but the specific architecture is not relevant to the principles of the present invention. The Cable Service Provider will transmit various cable programs, which may include channels conveying information provided by third parties, pay-per-voice movies, and other video assets provided on demand to various users. As used herein, “digital asset” refers to any type of information conveyed via digital signals from the Cable Service Provider, which can refer to various types of information provided to the STB. Typically, this includes video information capable of being presented to a user on a television, but could encompass music downloads, game software downloads, or other single or multi media applications which require a license to enable processing of the asset.

The Cable Service Provider obtains the digital assets in a variety of ways from various sources. For example, a Cable Service Provider can maintain a store of digital assets in the form of pay-per-view movies in a database, which are retrieved as requested for a user. The store of information may be populated by downloading and storing program information, such as from a satellite link, or by actual uploading of a physical media (e.g., DVD). Other digital assets may be received in real time by the cable services provided from a third party sources (such as using a network broadcast channel) and provided to subscribers in the cable system. Other information, such as advertisements may be stored locally and accessed as needed. Other digital assets could be requested in real time by the CSP and provided in real time in response to a user's request. The digital assets covered by the license include digital video assets (such as movies or other video programming); software, including gaming or application software programs, audio files, and other multi-media digital files.

The Cable Service Provider has a business relationship with the user or subscriber, and hence there is for purposes of convenience, a relationship between the Cable Service Provider and the STB of the user (regardless of whether the CSP owns the STB or not). Thus, it should be apparent in the context when used, that “STB,” “subscriber,” and “user” are used interchangebly at times. A set top box is typically associated with a subscriber profile, which contains information on the “subscriber.” A subscriber profile, which is maintained by the Cable Services Provider, typically includes information about the person responsible for payment of the account, and this is presumed to be the viewer or subscriber, although it recognized that other individuals in the household may be actually viewing the movie, and are not the actual nominal subscriber as indicated in the subscriber profile. A subscriber profile, in turn, is identified by a subscriber profile identifier, which allows retrieval of the subscriber profile.

Typically, the Cable Service Provider provides a programming package (e.g., a set of channels) to the user, and further allows the user to request at will specific programs for viewing for which there may be an additional charge. The present invention largely focuses on the digital rights management for the latter, e.g., requests made by the user for specific programs, which are not covered by the basic subscription service fees. However, as it will be seen, it is not necessary that the Cable Service Provider always separately charge the user for the requested program. In some cases, the Cable Service Operator could waive the fee, or otherwise include the fee within the subscription fees. However, typically, the user will be charged separately for each request license.

In other embodiments, the Cable Service Provider does not have to be a cable system operator per se, but could, for example, a hotel operator, which provides pay-per-view movies to its guests over a video distribution facilities in the hotel. Further, the Cable Service Provider does not have to provide cable services or use cable technology. Thus, the Cable Service Provider could encompass entities using wireless or Internet technology, or the provision of other services which are not typically associated with a cable system provider. Hence, the term “Cable Service Provider” as used herein should thus not be so limited to a traditional cable system operator per se.

The Cable Service Provider will also have a business relationship with a number of Content Providers. The Content Providers are presumed to be the owners of the content for which the license is being requested for, e.g., the entities that own various rights to the programming information provided to the Cable Service Provider. Obviously, the Cable Service Provider must have a business relationship with the Content Provider to distribute their digital assets, which manifests itself in the form of a license by the Content Provider. Typical examples of Content Providers would be national networks, such as ABC, CBS, and other entities, such as CNN, FOX, etc. Each of these entities may provide a license to a portion of their programming. For example, CNN may opt to provide a license to one or more of their various cable news programs. The license requests could apply to various types of programming, including real-time special events (such as sports events), regularly available programs (e.g., new channels), or recently released movies.

Content Providers are not suited, nor do they desire, to negotiate individual licenses with end users each of the possible programs on an “as-needed” basis. Negotiations with each STBs and its associated viewer would incur tremendous transaction costs to the Content Provider, which may be more than the cost of the individual license. Thus, in the present architecture, the Cable Service Provider serves as a broker or middleman, coordinating the request and response for a license between the Content Provider and the STB.

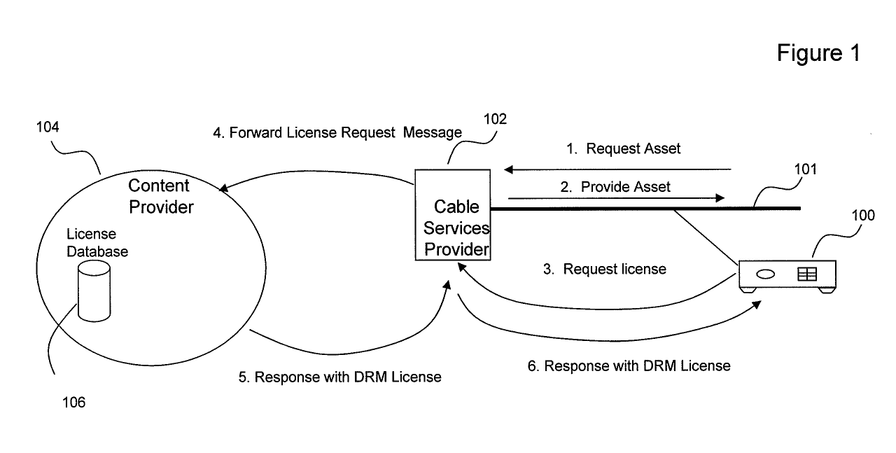

These three entities are represented in FIG. 1, which also illustrates in one embodiment of the invention, and the steps involved between the entities. The STB 100 is shown as connected to a cable network 101, which in turn is connected to the Cable Service Provider 102. The Cable Service Provider collectively represents all the equipment associated in providing services to the STB, and is represented by a single box, whereas it actually comprises a number of separate components. Thus, the representation of FIG. 1 does not imply or preclude any particular architecture or technology from being used by a Cable Service Provider to implement the present invention. FIG. 1 is used to illustrate the invention in terms of a user requesting a digital asset in the form of a movie, and this embodiment should be construed as limiting the scope of the claims beyond the limitations contained therein. Other architectures, technologies, and license types could be used and still be covered by the claims herein.

In a typical embodiment of the invention, a user (not shown) initiates a request for a particular asset, such as requesting a recent offering of a new movie. This type of offering, often called a “video on demand” service, are presently offered to cable subscribers, but there is presently no explicit request for a DRM license. The user typically utilizes a hand-held remote to initiate the request, and the STB then presents a menu option as an overlay on the presently viewed video image, if any, or on a blank screen. In a manner that is well known to those skilled in the art, the user is typically provided with choices or a search capability to select and identify a particular movie. As referred to herein, the more generic term “digital asset” will be used, which can encompass a variety of formats and types of information, including audio only (e.g., music) as well as video based.

After the STB has interacted with the user, the STB formulates a “Request Asset” message to the Cable Service Provider 102 in Step 1. The “Request Asset” is nominal in name, as any format or protocol known to those skilled in the art can be used to transmit the request from the STB to the headend.

The Cable Service Provider 102 receives the message, and acts to fulfill the request. At this time the Cable Service Provider may perform various other functions, such as ascertaining whether the digital asset is available, whether network resources exist to fulfill the request, whether the user is authorized to even make such a request, etc. Typically, the Cable Service Provider may have a set of servers which spool the asset as appropriate through various equipment and then to the user. After processing all the necessary steps, the Cable Service Provider will provide the requested asset, which is shown in Step 2 as “Provide Asset.”

In this embodiment, the Cable Service Provider has not modified the presently existing steps for requesting a movie in order to accommodate a DRM scheme. Specifically, the cables services provider has provided the digital asset regardless of whether the asset is restricted (and requires an explicit license or key by the STB to process the asset for viewing) or unrestricted (no license is require by the STB). Thus, if the STB 100 receives an unrestricted digital asset that can be played out, it will do so.

However, the digital asset may indicate that it is restricted to the STB by way of information included in the meta-data. Meta-data is data associated with the digital asset that indicates information about the digital asset itself. For example, if the digital asset is a movie, the meta-data could indicate the title, leading actors, a rating indicator, year of production, etc. The meta-data could also indicate that the digital asset is restricted—e.g., that an explicit license is required to view the digital asset. The license provides a digital “key” which is used by the STB to decrypt the content of the movie, so that it can be viewed by the user. Without the key, the encrypted digital asset is incapable of being viewed.

The STB is required to recognize and differentiate between those digital assets which are not encrypted, and can be viewed without requesting a license, and those digital assets which are encrypted and do require a key or license to view the program. This can be accomplished by downloading an application to the STB which is able to process the private data in the digital asset, and causes the STB to invoke the steps as described below. Once the STB recognizes the digital asset requires a license, the STB will formulate a request in Step 3 to the Cable Service Provider for a license. As will be seen below, the request can be transmitted to the Cable Service Provider in a variety of ways, and may or may not include address information identifying the Content Provider. In one embodiment that is discussed below, it is presumed that the STB does not know the identity of the Content Provider, and does not indicate an address of the Content Provider, but instead relies upon the Cable Service Provider to ascertain this information as necessary.

The STB provides an indication in the “Request License” message of Step 3 identifying which digital asset is the focus of the licensing request. Typically, this is indicated by using a digital asset identifier copied from the meta-data previously received by the STB. By indicating the particular digital asset involved, the STB presumed that the Cable Service Provider knows how to fulfill the licensing request. This involves the Cable Service Provider determining who is the appropriate Content Provider to forward the request to.

Turning to the Cable Service Provider, upon receipt of the “Request License” message from a particular STB, the Cable Service Provider will perform a series of screening functions. These screening functions are typically performed before the Cable Service Provider fulfills the request. The screening functions include ascertaining which STB initiated the request, ascertaining that the STB is a valid STB (as opposed to an unauthorized STB connected to the network), and that the STB is assigned to a customer in good credit standing, Other types of screening functions may occur, and an exhaustive list is not necessary to illustrate the types of screening that occurs at this point.

The Cable Service Provider uses the digital asset identifier to ascertain which of potentially several different Content Providers the request should be forwarded to. Although FIG. 1 illustrates a single Content Provider 104, it is anticipated that a plurality of Content Providers will exist, each of which is capable of providing a license for their digital assets upon request, where the license allows the STB to decrypt the digital asset for viewing. The Cable Service Provider will typically use a table or other data structure in a database to match the digital asset identifier with a Content Provider. It is also possible that a third party service provider could provide an address lookup service. For example, the third party service provider when queried would receive the digital asset identifier and return the appropriate Content Provider address (for example, an URL or IP address). In yet another embodiment, the address itself or other explicit identification of the Content Provider could be included in the digital asset, and incorporated in the request by the STB to the Cable Service Provider.

The Cable Service Provider acts as a broker between the STB and the Content Provider. The Content Provider does not have individual billing accounts for each STB, nor is it seen desirable to do so. Rather, the Content Provider has a business relationship with the Cable Service Provider, and bills the Cable Service Provider for providing licenses indirectly to the STB, and the Cable Service Provider in turn, bills the subscriber for each license which was provided to the subscriber's STB. The terms and details of the billing between the Content Provider and the Cable Service Provider is typically not the same between the Cable Service Provider and the STB. The relationship between the Content Provider and the Cable Service Provider is akin to a wholesale or business-to-business relationship, whereas the Cable Service Provider is akin to a retail or retailer-to-consumer relationship.

Returning to FIG. 1, the Cable Service Provider will forward the “License Request” message in Step 4 to the Content Provider. The message format may be the same as that as sent by the STB, or it may be reformatted or embedded in another message. The message is typically transmitted over a data network, such as the Internet, although other types of facilities and data transmission protocols could be used.

The Content Provider functions as a licensor, and the terms “Content Provider” and “Licensor” can be used interchangeably to an extent. The Content Provider receives the requests and also performs a series of screening steps. Again, the exact number and nature of the screening steps may vary from embodiment to embodiment. The Content Provider will first ascertain that it has a business relationship with the Cable Service Provider, and that the Cable Service Provider is in good credit standing with the Content Provider. The Content Provider may also examine the STB identification to ascertain whether the STB is an unauthorized STB or otherwise indicated as a “rogue” STB. For example, a single STB may request multiple licenses within a time period of 24 hours, but typically, this would not exceed a certain threshold (e.g., 12). If the Content Provider received, for example 100 requests within a 24 hours window, it is suggestive that there may be multiple cloned STBs having the same identifier. Alternatively, if the Content Provider receives two requests from the same STB but from two different Cable Service Providers, this also could be suggestive of a cloned STB.

Thus, the Content Provider may maintain a “black-list” database or table of STB identifiers that are not entitled to receive licenses, because of such suspicious requests or a history of other problems. Any unusual activity regarding requests originating from a STB may result in the Content Provider adding the STB identifier to the blacklist database, and denying the license request. Thereafter, any other subsequent request would also be denied when the Content Provider checks the blacklist STB identifier database. Instead of the Content Provider owning and operating this database, it is possible that a shared, commonly accessed database could be operated by a third party which is accessible by a plurality of Content Providers. This would allow Content Providers to quickly identify any cloned STB boxes.

After screening the request, the Content Provider will determine whether a license is available. There may be a limited number of licenses that can be provided, or a license may be limited based on other factors. For example, a Cable Service Provider may have a business relationship with a Content Provider for movies, but not for real-time sports events. Alternatively, there may be a time limitation on granting licenses. For example, the Content Provider may not grant a license to a real-time sports event when there are only 5 minutes remaining in the program event. Certainly, when the program is a live program, and the live program has ended, the Content Provider may refuse to grant a license for such a request. If the program is subsequently made available as a recording, then a license, which may be a different license, may be granted for the recorded version of the program.

The granting of the request is recorded in the License Database 106 so that a record of which licenses were granted and to whom is maintained by the Content Provider. The database may record the STB identifier associated with the request, as well as the Cable Service Provider forwarding the request, as well as information about the license itself. The maintenance of this information allows the Content Provider to perform various functions in non-real time, such as verifying what licenses were provided, properly billing the Cable Service Provider for licenses granted, analyzing license requests to better understand marketing trends, and to potentially identify cloned STBs.

Once the Content Provider has completed the screening functions, and recorded the license grant, the Content Provider responds in Step 5 with granting the DRM License. The license itself may have various qualifiers associated with it, including that the license is only valid for a certain time period. Alternatively, the license may be unrestricted in time. A time limited license would require that the license be used for its intended purpose within a set time period, which could be as short as a few minutes, or as long as several days. In addition, the license may be limited to viewing a digital asset, or allowing the digital asset to also be copied or downloaded to another device a certain number of times (e.g., a portable device capable of storing a video for future viewing).

The Cable Service Provider receives the response, and is able to correlate the response with the request by using a correlation identifier. The correlation identifier is merely a number that is dynamically selected whenever a request is made, that identifies that particular request, and allows the request to be distinguished from other requests. Upon receiving a response message having the same correlation identifier, the Cable Service Provider is able to match up the response with the request. In this manner, the Cable Service Provider knows that the original request has been acted on.

In processing the response, there is less processing typically involved by the Cable Service Provider than in making a request. There is little, if any, screening involved when processing a response, and the response itself is typically forwarded to the appropriate STB. Typically, the message itself includes the STB identifier, otherwise the Cable Service Provider would have to maintain the association of the STB identifier with the request/response messages. In Step 6 of FIG. 1, the Cable Service Provider sends the DRM Response message containing the license to the STB. Typically, the Cable Service Provider will also record each license grant so as to properly bill the subscriber.

Upon receiving the license, the STB typically will immediately process the license to authorize use of the requested asset for viewing. Typically, the process occurs in real time with a user making a request for a license to view a video, and when the response is received, the video is presented to the viewer. In other embodiments, the viewer may be requesting a license so that the movie could be downloaded into a portable video player, where the actual viewing occurs in the future. Typically, the downloading of the movie into the portable device would occur shortly after the license is received.

### Set Top Box Processing

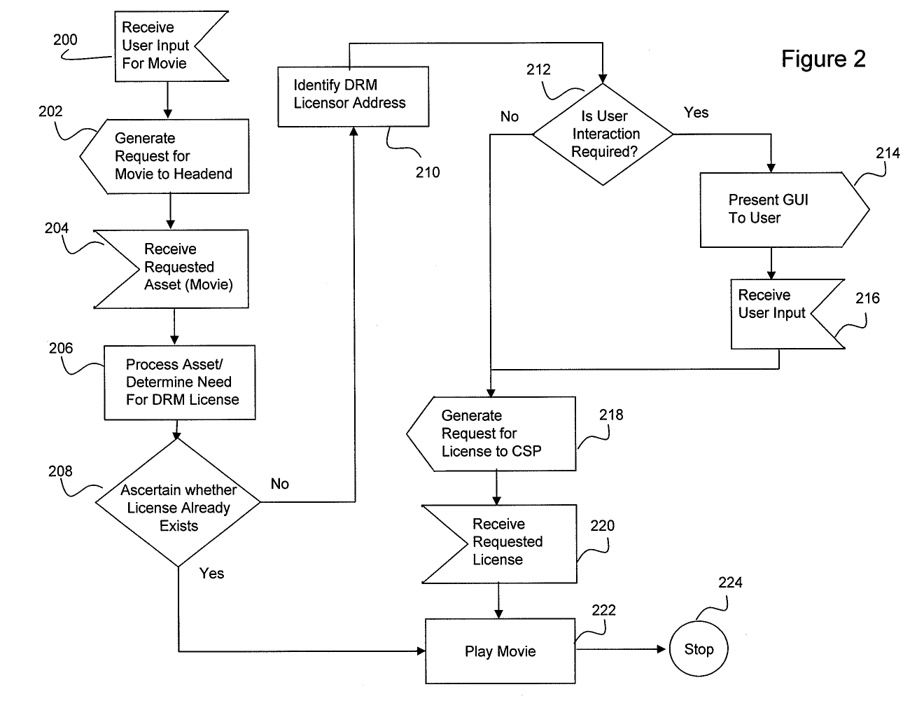

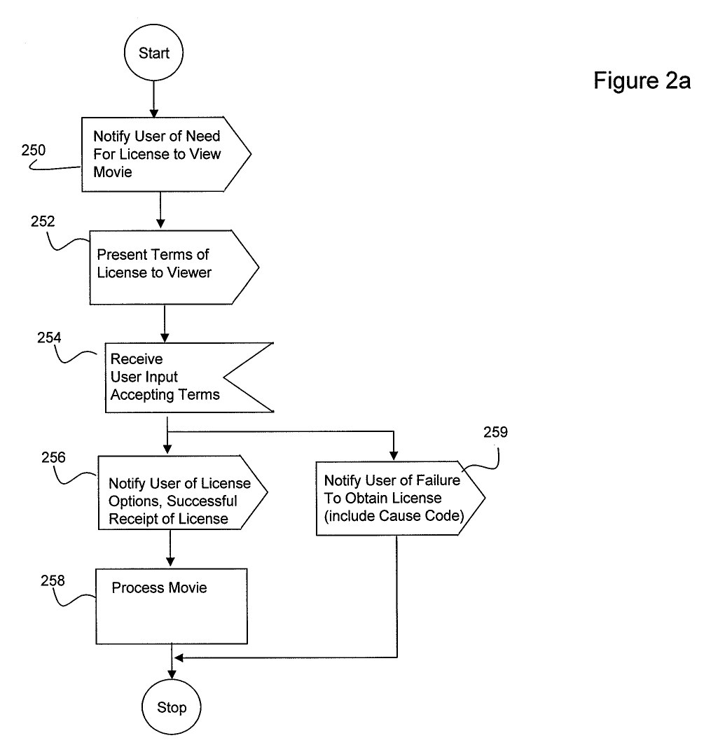

FIG. 2 illustrates one embodiment of the processing that can occur in the STB in conjunction with processing a user's request for a license. In step 200, the process is initiated by the user making a request typically for a movie to watch, which is indicated by pressing a designated button or key on a remote controller. Alternatively, the user may manipulate a cursor appearing on the television screen using “arrow keys” on a remote controller until the desired movie title is selected, and they pressing a separate key to request purchase of the movie. A variety of methods may be used by the user to indicate a particular selection, and those skilled in the art will appreciate a variety of graphical user interface techniques can be used.

In Step 202, the STB has received the necessary information regarding the user's selection, and generates a request to the Cable Service Provider for the particular movie. The signaling at this point may utilize existing techniques, and is not impacted by whether or not the particular movie requires an explicit license in order to view the movie.

In Step 204, the movie is downloaded or streamed to the STB for viewing. At this point, the STB in Step 206 begins to process the movie, and determines from various data included with the movie that the movie is protected and requires an explicit license in order to display the information to the user.

In Step 208, the STB ascertains whether the required license is to be obtained, or whether a license already exists in the STB. In one embodiment, the license must be obtained, and the procedures below are generally followed. The license obtained could permit multiple viewings of the movie (such as an unlimited ‘movie pass’ for viewing the movie within a 24 hour period).

Thus, it is possible that when the user initiates a request to view a movie, a previously granted or obtained license could already by present in the STB. If so, then there is no need to request a license. The license could already exist in the STB because of the scenario described above, or the Cable Service Provider could have provided a license for promotional reasons. For example, the Cable Service Provider would obtain the license from the Content Owner as described (and according to terms of the business agreement between the Cable Service Provider and Content owner, as already described), and deliver it to the STB as part of a promotion or in anticipation of the user making a request. An example of a promotion would be to provide a user a license for a movie and advertise to the user that movies on a specific channel are free for a specified weekend. Alternatively, the Cable Service Provider could derive a movie viewing pattern for a user, and obtain the license in advance for that user, in anticipation of that user making the request. By pre-loading the license in the STB, the Cable Service Provider might improve the user experience by eliminating the delay otherwise required to provide the license from the Content Provider. In such instances, the STB may provide notice to the Cable Service Provider that it has used a license for viewing a movie, so that the Cable Service Provider is aware of the actual usage by the STB, and account for its use.

Regardless of the reasons for providing a license to the STB, if a valid license already exists for the movie, the STB may proceed to Step 222 where the movie is played thus avoiding the need of the STB requesting a license.

If a license does not already exist in the STB, then the STB will proceed to Step 210 which obtains information about the DRM Licensor address and other license related information.

At this point, at Step 212, the STB may interact with the user. In FIG. 2, the interaction is shown in Step 214 as a single step, but typically involves a number of steps, including receiving input from the user as shown in Step 216.

The interaction with the user is accomplished by executing a program that informs the user of the fact that a license is required to view the movie, and informs the user of various terms and other conditions. A typically interaction of an embodiment is shown in FIG. 2A, which first involves in Step 250 the STB notifying the user of the need for a license, and then in Step 252 presenting various terms and/or conditions of the license to the viewer. One of the terms may include the additional charge levied on the subscriber's bill for the service. In this embodiment, the user is required to accept the terms in Step 254, which can be accomplished by selecting an appropriate key on the remote. Step 256 illustrates providing additional information to the user, which may reflect the successful receipt of the license from the Content Provider, and specific aspects of the license, such as the ability to download the movie to a portable device, or that it can be viewed a limited number of times within a defined time period. In other embodiments, the notification may be simply to inform the user that a previously received license exists and is being used for viewing the movie, and that the user may have only a limited number of uses remaining for that license. After this point, the movie can be processed for viewing in Step 258. Alternatively, if the license is not obtained, Step 259 may be executed which informs the user that the license could not be obtained, and preferably indicates the reason for the failure and instructions for contacting a customer service representative to resolve any problems that might exist.

The information presented to the user, and the information required to be collected can vary. Some embodiments may simply inform the viewer of the need of a license and proceed with processing of the request without waiting for the user to confirm. Other embodiments may inform the user that an additional charge will be assessed if the user continues and explicitly receive the user's confirmation of the charge. Other embodiments may request the user to enter an authorization code or PIN code in order to indicate their authorization. This mechanism would aid in avoiding unauthorized purchase of movies in a household involving multiple individuals, since only those possessing the PIN code could authorize the purchase of a license to view a movie. Thus, a variety of graphical user interactions may be defined at this point to inform and instruct the user as to the terms of the license.

As evident, the series of steps shown in FIG. 2a depicts the interaction between the user and the STB under normal conditions. Some of the steps may be dependent on the steps shown in FIG. 2. For example, Step 256 in FIG. 2a is dependent on the successful receipt of a requested license.

Further, the sequence of steps can be expanded or eliminated based on the particular embodiment of the invention. Some embodiments may have minimal interaction with the user and not utilize these steps. For example, the STB could simply request the license without notifying the user that a license is required. Other embodiments may define a detailed interaction with the user, even allowing the user to pay for the license by interacting with a menu to provide a credit card for real-time payment.

Returning to FIG. 2, once the interaction with the user is completed, Step 218 is executed which involves the STB sending a request for a license to the Cable Service Provider (“CSP”). The STB waits for a response, and in Step 220, the requested license is received, which allows the STB to proceed to Step 222 in which the movie is played.

If a license is not received, a return message indicating a cause code or the reason for the denial may be sent. This can be used by the STB to invoke another process informing the user of the error and how it can be rectified, such as trying again later or contacting the Cable Service Provider for assistance. This is shown in FIG. 2A as Step 259.

### Cable Service Provider Processing

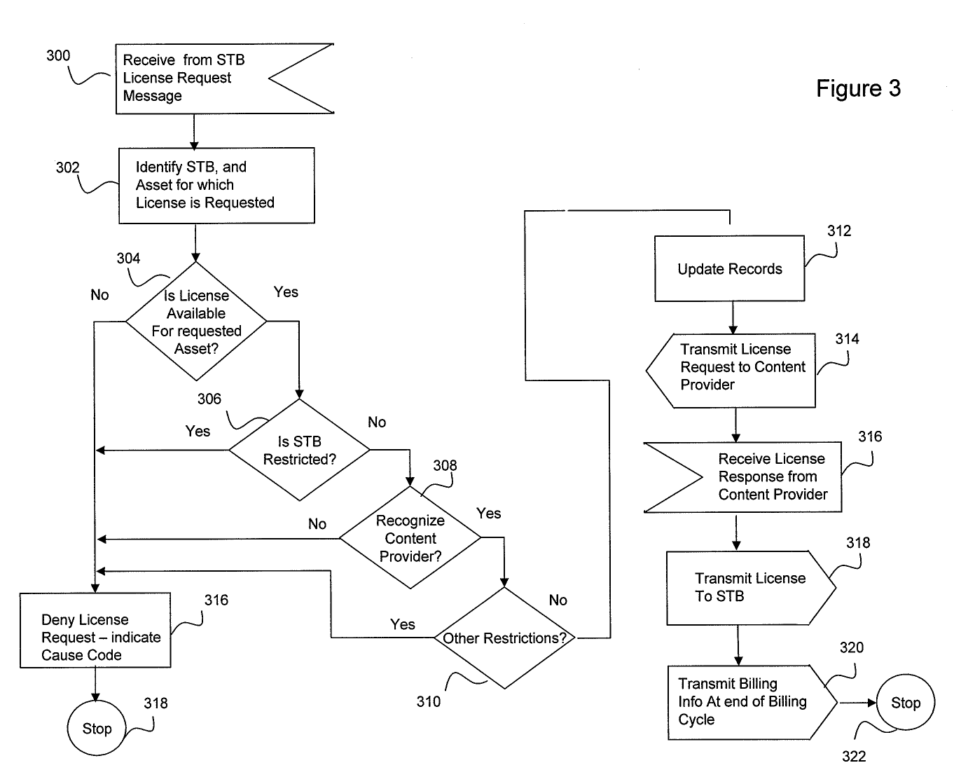

FIG. 3 illustrates one embodiment of the processing steps that may occur at the Cable Service Provider in processing a license request. In Step 400, the Cable Service Provider receives a licensing request from the STB. This can be transmitted in a variety of upstream communication paths from the STB to the headend.

In Step 302, the Cable Service Provider parses the message to ascertain at least two pieces of data: first is the identification of the STB making the request and second is the identification of the digital asset or movie requested. The STB identification is typically a unique numerical identifier, such as a serial number or other digital certificate associated with the STB. It is presumed that the Cable Service Provider is able to identify the customer account based on the STB identifier.

The Cable Service Provider then initiates a series of tests, which are represented by the cascading tests shown in Steps 304, 308, and 310. The nature and numbers of these tests may vary, but are sufficient to illustrate the principles of the present invention. Typically, the Cable Service Provider will first use the digital asset identifier to determine whether a license can be requested. In other words, the Cable Service Provider will ascertain whether it has a business relationship with the appropriate Content Provider that provided the movie. There may be a variety of Content Providers and the Cable Service Provider may not have a business relationship with each one, or may not have a business relationship for requesting a license for the type of digital asset indicated. Preferably, the Cable Service Provider would never download to a subscriber a digital asset which requires a license, but for which the Cable Service Provider in unable to fulfill the request. However, it is possible that this may occur, so that testing this aspect may be warranted.

Next, the Cable Service Provider may test in Step 308 whether the STB is authorized to make the license request. The STB may be an unauthorized STB, or be identified as a “cloned” STB which should be denied the ability to receive a license. In other instances, the STB may be associated with a credit challenged subscriber, resulting in the license request being denied. In such cases, a process may be invoked requesting the caller to enter a credit card number of the requested viewing. In Step 310, any other type of screening test is shown, such as previously established restrictions which the Cable Service Provider maintains (such as preventing fulfillment of license requests for adult movies).

If for any reason the screening of the license request results in the request being denied, the process at Step 316 occurs, which results in the Cable Service Provider sending a reason or cause code to the STB indicating that the license request could not be fulfilled, and indicating why.

If the license request can be fulfilled, then in Step 312, the Cable Service Provider will log the request for the license in a database. In other embodiments, a database will log all requests, including those requests from STBs which were denied.

In Step 314, the Cable Service Provider will forward the license request to the appropriate Content Provider. The appropriate Content Provider may be ascertained a number of a ways. First, the Cable Service Provider may have a database or other table lookup memory for determining the Content Provider based on the digital asset identifier. This presumes that each digital asset is uniquely identified. Alternatively, the Cable Service Provider can query a third party entity which provides this look up capability. Second, the license request itself could indicate either a name or address of the Content Provider. This presumes that the name or address is indicated in the movie information, and that the STB extracted and copied this information into the license request.

In either case, the Cable Service Provider transmits the license request to the appropriate Content Provider in Step 314, and will typically include information identifying the Cable Service Provider to the Content Provider.

In real time, the Cable Service Provider will receive a response in Step 316 from the Content Provider, and will log the response (not shown) and forward the information in Step 18 to the STB. The Cable Service Provider will also periodically use the logged requests from the STB, along with the actually received response information from the Content Provider, to resolve the appropriate billing information for that STB. This occurs in Step 320, which happens on a periodic basis, typically in accordance with the user's billing cycle. After this step, the process is completed in Step 322 for the Cable Service Provider.

### Content Provider (Licensor) Processing

The Content Provider is presumed to be the Licensor, and the terms are used interchangeably. However, it should be recognized that the Content Provider does not necessarily have to be the Licensor, as the Content Provider could use a third party entity for processing licensing requests. For purposes of describing the invention, it will be assumed that the Content Provider is both responsible for providing the content and licensing the content as well.

The Content Provider typically does not provide the content simultaneously with the request for the license, but has previously provided the content to the Cable Services Provider. Thus, the provision of the content from the Content Provider to the Cable Service Provider may occur using existing techniques known to those skilled in the art.

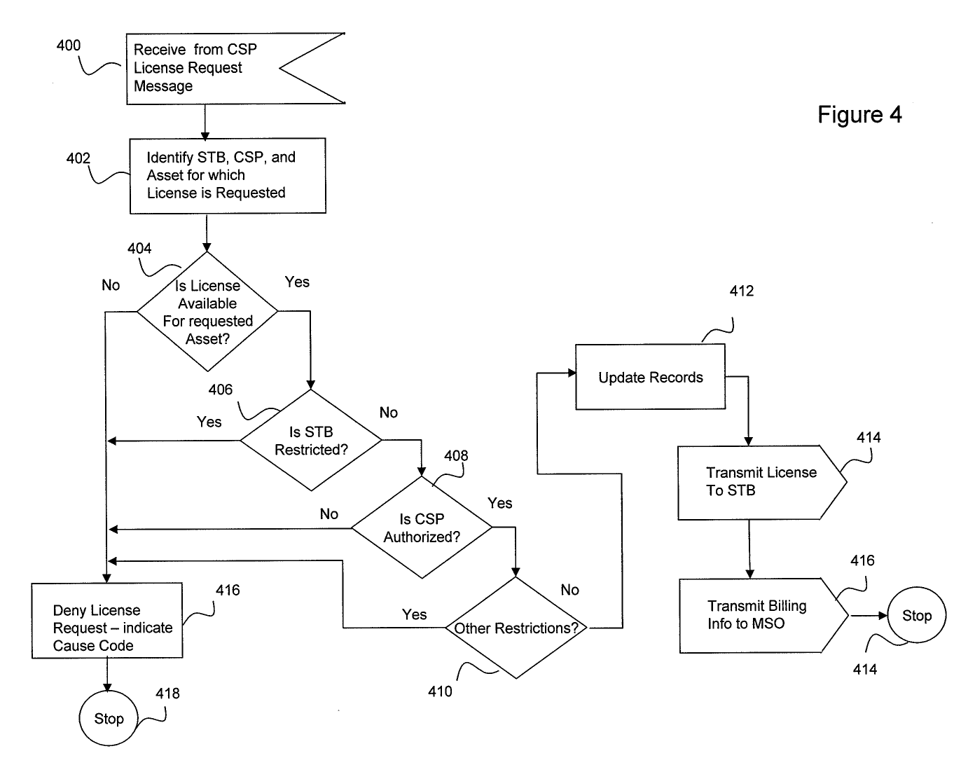

One embodiment of the processing that may occur in the Content Provider is shown in FIG. 4. In FIG. 4, the process begins in Step 400 with the Content Provider receiving a license request message from a Cable Service Provider. Typically, the message is received over the Internet, and the originating address will indicate the particular Cable Service Provider. In other embodiments, a separate protocol element conveyed by the Internet message will identify the particular Cable Service Provider.

In Step 402, the Content Provider will extract various elements in the request message, allowing the Content Provider to identify the STB making the request, the Cable Service Provider forwarding the request, and the particular digital asset requested. Although the asset requested will often be a movie, it could be any format of a digital asset, including for example, audio only (music) or game software.

The Content Provider will then perform a series of tests, which are represented by the cascading tests shown in Steps 404, 408, and 410. These tests are illustrative, and additional or other forms of tests may be carried out in order for the Content Provider to fulfill the request. Further, the order the tests are performed can vary. If any one test fails, then a response in Step 416 is sent, which includes a reason or cause code as to why the request could not be fulfilled.

The first test shown in Step 404 and involves the Content Provider determining, based on the digital asset identified in the request, whether a license can be granted for the digital asset. It may be that the digital asset is not associated with the Content Provider, or that other time or numerical limits are imposed for that digital asset. For example, only 10,000 licenses may be granted in total or at any give time, or that no licenses may be granted after a certain time (because the digital asset is only available for licensing as live broadcasted event, and which has completed). Any number of potential restrictions based on the digital asset can be defined at this stage of testing.

The next test is shown at Step 406, which tests the STB identity. The Content Provider may chose to implement a “blacklist” STB database, which could represent a list of unauthorized STBs, such as those which are determined to have been cloned. Because the Content Provider receives requests from multiple Cable Service Providers, the Content Provider is capable of detecting duplicate STB identifiers across multiple cable systems that any given one cable system would not be able to easily detect. Again, there may be any numbers of reasons why the Content Provider may desire to restrict providing a license to a particular STB, and this would be covered at this stage of testing.

If the STB screening is successful, then the next stage of screening is based on the Cable Service Provider identification. The Content Provider must have a business relationship with the Cable Service Provider, and it is possible that the Cable Service Provider is not in good credit standing, or otherwise restricted from fulfilling license requests. It may be that the Cable Service Provider is authorized only for certain types of licenses (e.g., pre-recorded movies but not real time streamed sports shows). Again, there may be any numbers of reasons why the Content Provider may desire to restrict providing a license to a Cable Service Provider and would be covered at this stage of testing.

If all the screening tests are passed, then the license will be granted. Each granted license is referred to herein as a “license grant.” First, in Step 412, the Content Provider will log the request, and then in Step 414, the Content Provider transmits the license request to the Cable Service Provider.

Finally, Step 416 is shown as the Content Provider billing the Cable Service Provider, but this step typically does not occur after every very license grant, but only periodically, such as on a monthly basis according to the billing cycle for the customer. The billing information is generated from the logged records of license grants which are stored in Step 412. However, if the Cable Service Provider is a hotel providing pay-per-view services, then the Content Provider may bill the Cable Service Provider immediately, to facilitate the determination of the appropriate charges levied against the guest that request the movie. This is not required, but is another embodiment.

The license grants are stored in a database in Step 412, and the database is used as input in generating bills to the Cable Service Provider. The database also stores denied license grants from step 416, and these may be used to identify Cable Service Providers with operationally problematic STBs. In addition, the database storing the license grants provides a source for mining the requests to perform marketing analysis based on the frequency and nature of the requests. This processing is separate from the processing required to fulfill a STB request for a license.

### Message Formats

Any number of different message formats can be used to convey the request message from the STB to the Cable Service Provider, and from the Cable Service Provider to the Content Provider. Similarly, this applies for the response message formats. It is not even required that the message formats for the response between the STB and the Cable Service Provider be the same format or structure between the Cable Service Provider and the Content Provider. Those skilled in the art will recognize that various formats that could be used to accommodate various design priorities.

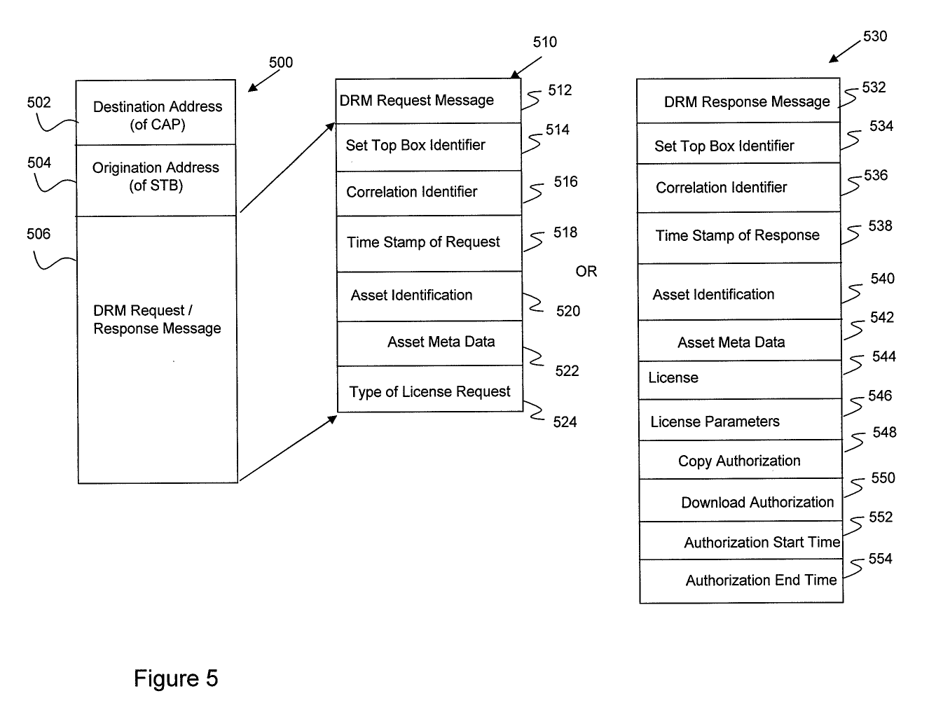

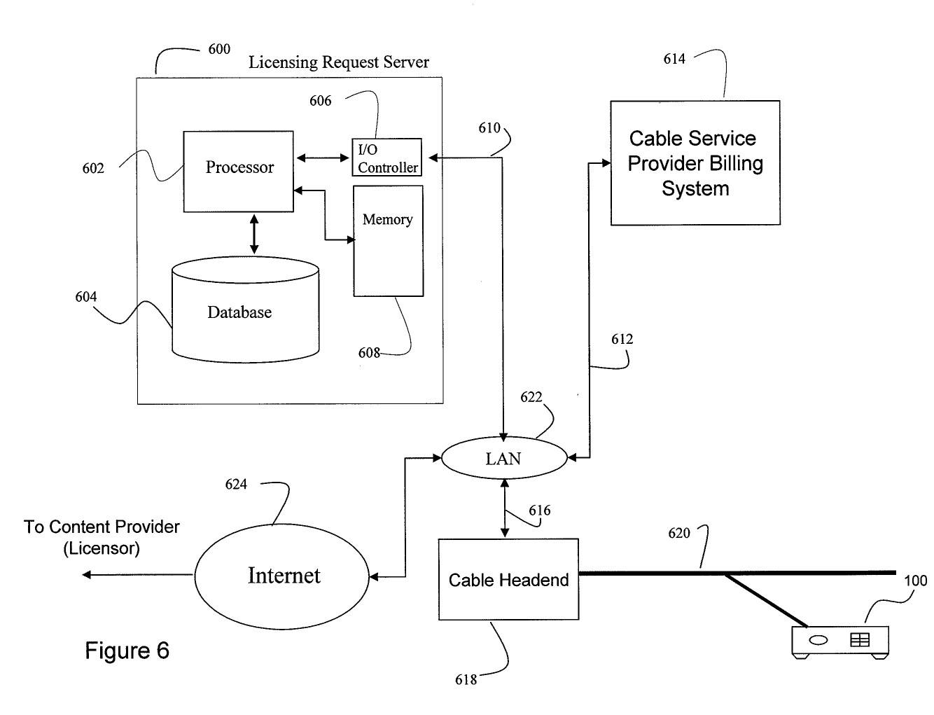

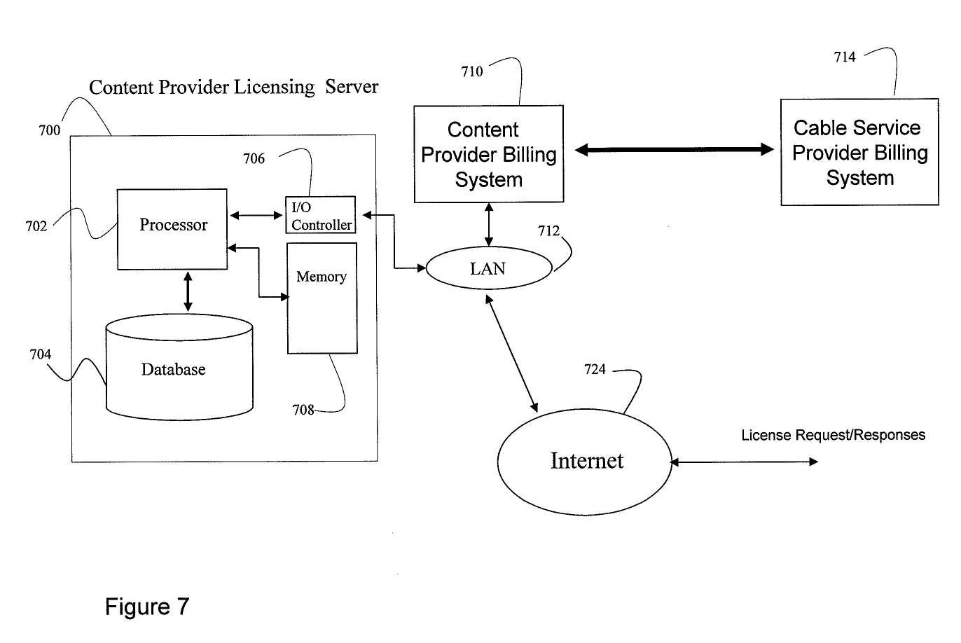

In FIG. 5, one embodiment of the message formats are disclosed. This is based on the STB to the Cable Service Provider messaging, but could be amended for the Cable Service Provider to Content Provider messaging. The basic message format 500 is based on an IP based message which has a destination address 502 which identifies the Cable Service Provider and an origination address 504 of the STB. A payload field 506 contains the DRM Request or DRM Response message. Although the message format 500 is shown as having both an origination and destination address, this is not required, as the STB can merely send it to the cable headend of the Cable Service Provider, and the Cable Service Provider can identify the STB via an identified contained in a higher layer protocol. Thus, structure of the message 500 is illustrative of one embodiment.

Another layer protocol, specific to requesting a DRM license and responding thereto is conveyed by the IP layer address message format 500. Two message formats are shown, namely a DRM Request Message 510 and a DRM Response Message 530. The DRM Request Message 510 is conveyed from the STB to the Cable Service Provider and comprises various information elements. First, the message type identifier 512 indicates that the message is a “DRM Request Message” as opposed to some other message, such as a “DRM Response Message.”

The next information element is a “Set Top Box” identifier 514, which may contain a MAC address, serial number, or some other type of unique identifier associated with the STB. In one embodiment, the STB identifier would be a digital certificate. Using asymmetric cryptography, the Set Top Box would contain an embedded private key, and would provide a corresponding public key in the public certificate as its identifier. The Content Provider would use that public key to generate a license specific to that particular Set Top Box. The Set Top Box would be required to use its private key to access the key in the license. Since only that unique Set Top Box would possess the necessary private key, only that set top box would be able to use the license to decrypt the asset. This technique would be understood by anyone well versed in the art of public key cryptography.

Next, a “Correlation Identifier” 516 is included, whose purpose is to allow the response message to be correlated with a prior request message. A “Time Stamp of Request” 518 is included, which allows the Cable Service Provider to ascertain a relative time of the request to other requests, which may be useful in determining a priority. In other embodiments, the time stamp may be granular enough to use it as a unique number in lieu of the Correlation Identifier.

The “Asset Identification” identifier 520 is a necessary element in order to identify the particular movie or digital asset that the user is requesting a license for. The “Asset Meta Data” 522 may be included, and may be copied by the STB from information provided with the digital asset, and could include, for example, information to identify the Content Provider. This could be an explicit identifier, address, or other information. Finally, the message may include “Type of License Request” information 524, which indicates whether special attributes of the license are requested, such as a license for downloading or copying the digital asset.

A “DRM Response Message” 530 is also shown in FIG. 5, and this represents the response message sent by the Cable Service Provider to the STB. The message contents include an “DRM Response Message” 532 identifier, which is used to distinguish this message from other message types. The “STB Identifier” 534 is not required, but it allows confirmation by the STB that the message is actually intended for it, as opposed to some other device. This can also be accomplished by the “Correlation Identifier” 536, which allows the STB to correlate this response message to the prior request message. A “Time Stamp of Response” 538 may be included as it provides a reference that can be used to start a time from which the license may be valid.

The “Asset Identification” 540 information allows the STB to confirm that the license is associated with a particular asset. Again, this may not be included, but it facilitates identification of errors. Similarly, the “Asset Meta Data” 542 may also be included.

The “License” information 544 is required to be provided in the response (except when a license cannot be provided). The License allows the STB to process the digital asset so that the asset can be viewed by the user. The License may further include various other information conveyed with it, such as various “License Parameters” 546 which can include: “Copy Authorization” information 548, “Download Authorization” information 550, and an “Authorization Start Time” information 552 and “Authorization End Time” information 554.

A license can be granted that is restricted to a single viewing by the user, where the STB performs the processing of the digital asset. However, other variations are possible, such as a single viewing, which must occur before a certain time (as indicated by the Authorization End Time). The license may grant a limited number of viewings or an unlimited number with a time frame.

The license may authorize the STB to download the digital asset to another device, such as a portable video player. This also may be limited as to the number of time, or within a certain timeframe. Similarly, parameters can be defined allowing the movie to be copied, such as onto a DVD. Thus, it is possible for a user for purchase a permanent copy of a movie, provided the licensor has offered that option.

In the scenario where the license granted by the Content Provider is based on a digital certificate from the Set Top Box, the license could be transferred to another device (e.g., mobile device) when permitted as follows: the Set Top Box would extract the content decryption key from the granted license using the STB private key, and re-encrypt the content decryption key using the public key from a digital certificate belonging to the mobile device, in a manner analogous to the way the Content Provider generated the original key for the STB. This technique would be understood by anyone well versed in the art of public key cryptography.

As stated, there are many variations on the protocol and procedures that can be used in various embodiments of the invention, which is limited only by the claims provided herein.

### Cable Service Provider System Architecture

The system architecture for an embodiment that can be used by a Cable Service Provider is shown in FIG. 6. In FIG. 6, the STB 100 is connected to the cable network 620 which is then connected to a cable headend 618 of the Cable Service Provider. The cable headend transmits and receives information with the STB, and identifies any licensing requests for processing by the Licensing Request Server 600. This is accomplished by the cable headend 618 identifying licensing request message separate from other messages and directing those messages over a connection 616 to a corporate LAN 622, and then over another facility 610 to the licensing request server 600. While it is possible in other embodiments to integrate the licensing request server with other servers associated with the cable headend, the licensing request server is shown as a separate system for purposes of discussion. It is not required that the licensing request server be co-located with the cable headend, and for many Cable Service Providers having multiple cable headends, the licensing request service could be physically located in another area (e.g., city or state) relative to the cable headend.

The licensing request server comprises an input/output controller 606, which provides connectivity to the processor 602, which in turn is capable of storing or retrieving data either in a memory 608 or a database 604. Typically, a licensing request message is received by the processor, and stored in memory 608 for immediate processing purposes, but may also be logged for permanent storage in the database 604.

The processor will perform the various aforementioned screening functions, and this may require accessing customer records either stored in the database, or in the Cable Service Provider billing system 614. Once all the screening and recording functions have occurred, the processor will initiate a licensing request to the Content Provider. This could involve completely reformatting the licensing request message, or merely encapsulating it into another message. Regardless, the message is sent over the connection 610 to the LAN 622, but then to the Internet 624 which then eventually is transmitted to the Content Provider.

Although the Internet is shown as the communications network providing message transport between the Cable Service Provider's licensing request server and the Content Provider, other communication facilities can be used. In many applications, a proprietary protocol may be used.

The responses from the Content Provider are received in essentially using a reverse path. Specifically, the messages from the Content Provider are conveyed by the Internet 624 to the corporate LAN 622 and then to the Licensing Request Server 600. There, the response message is correlated with the request message. The processor will typically use a correlation identifier to retrieve the appropriate message from memory 608, to correlate the response/request messages.

The processor 602 will process the response message, which will essentially provide a license or deny a license. Regardless, the response will be recorded in the database 604, and the processor will communicate the result to the STB 100.

If a license is granted, the processor 602 will communicate via the LAN 622 with the Cable Service Provider's Billing System 614. The communication may be on a per-query basis, or on a periodic basis. A periodic basis allows the licensing request server to store all responses, and then update the billing system for a number of licensing responses. Alternatively, the communication with the billing system could occur at the beginning of licensing request process, but because billing is predicated on the successful granting of a license, appropriate steps are necessary to ensure that the recorded information accurately reflect the response to the license request.

The Billing System 614 tallies the number of licenses requested/granted for each subscriber and processes this information using various business rules in order to compute the appropriate charge for the subscriber. The billing of the subscriber is a separate function from the process of requesting and responding to the licensing request.

The architecture for the Content Provider to process a licensing request is shown in FIG. 7. This is similar to the architecture shown in FIG. 6, in that requests are provided from the Cable Service Provider to the Internet 724, which are directed by a LAN 712 to the Content Provider's licensing server 700. The licensing server also has an input/output controller 706, memory 708, processor 702, and database 704.

Requests are received by the processor 702 in a message format as agreed upon between the Content Provider and the Cable Service Provider. The processor performs the necessary screening and testing as describe before, and provides a response message either granting or denying the license to the Cable Service Provider. The response message is sent from the processor 702 to the LAN 712, back to the Internet, and to the Cable Service Provider.

The Content Provider also maintains a record of license requests and license grants/denials. This is used by the Content Provider to ascertain whether certain originating STBs are invalid. For example, the Content Provider may process the logged requests and ascertain that the same STB identifier is making requests on multiple Cable Service Provider networks, which is indicative of a “cloned” STB. The information could also be processed to measure the effectiveness of marketing campaigns and/or design future marketing campaigns.

The Content Provider will also periodically process the license requests/grants in a billing system 710, which can retrieve data in the database 704. The Content Provider billing system 710 tallies the licenses granted to STB of a particular Cable Service Provider, and will periodically generate a bill to the Cable Service Providers' billing system 714. This communication may also occur using the Internet (although this is shown as direct form of communication in FIG. 7.) The Content Provider will bill the Cable Service Provider on the terms established between the two entities, which are likely not the same as between the Cable Service Provider and its subscriber. Typically, the terms reflect the large number of transactions between the Content Provider and the Cable Service Provider, and provide for the appropriate discounts.

That which is claimed:

1. A system for processing licensing requests from a set top box on a cable system comprising:
a cable headend connected to a cable distribution network, said cable headend capable of receiving a licensing request comprising a first licensing request message from a set top box connected to said cable distribution network wherein said cable headend is configured to forward said first license request message;
a licensing request server connected to said cable headend receiving said forwarded first licensing request message, said licensing request server comprising a:
processor configured to receive said first licensing request message and identify 1) a digital asset indicated by a digital asset identifier in said license request message and 2) a set top box indicated by a set top box identifier generating said licensing request message, said processor configured to store said first licensing request message in a memory, said processor configured to determine a subscriber profile associated with said set top box identifier, said processor configured to ascertain a network address of a licensor to generate a second licensing request message based upon said first licensing request message, wherein said second licensing request includes said digital asset identifier and a cable system identifier associated with said licensing request server, and
a database accessible by said processor storing an association of said set top box identifier with said subscriber profile; and
a billing system capable of communicating with said licensing request server, said billing system configured to store said digital asset identifier in association with said subscriber profile indicated in said first licensing request message in a billing system database.

2. The system of claim 1 wherein said processor is configured to include in said second licensing request a correlation identifier, said processor further configured to receive said first licensing response message comprising said correlation identifier and a license wherein said license can only be used by said set top box, said processor configured to generate a second licensing response message to said set top box, said second licensing request comprising said license.

3. The system of claim 2 wherein the processor is configured to generate the second licensing response message using a message format different from said first licensing response message.

4. The system of claim 1 wherein said processor is configured to include in said second licensing request a correlation identifier, said processor further configured to receive said first licensing response message comprising said correlation identifier and a denial code, said processor configured to generate a second licensing response message to said set top box, said second licensing request comprising said denial code.

5. The system of claim 1 wherein said licensing request server generates a billing message to said billing system after receipt of a first license response message from a licensor, said billing message conveying the digital asset identifier, either the set top box identifier or a subscriber profile identifier, and a license grant identifier signifying a license was provided to said set top box.

6. The system of claim 1 wherein said licensing request server after receiving said first licensing request message is configured to use said set top box identifier to screen the licensing request using data in said database to determine whether to generate said second licensing request.

7. The system of claim 6 wherein said licensing request server screens the request further using the digital asset identifier to determine whether the subscriber profile is authorized to receive a license for said digital asset.

8. The system of claim 1 wherein said first licensing request message indicates said network address of said licensor.

9. A method of processing a licensing request comprising the steps of:
receiving a first licensing request message from a set top box connected to a cable network of a cable service provider, said first licensing request message comprising a digital asset identifier identifying a digital asset for which a license is requested and a set top box identifier identifying said set top box;
ascertaining in a licensing request server receiving said licensing request message a subscriber profile associated with said set top box identifier;
using said subscriber profile to determine said set top box is authorized to obtain a license for viewing said digital asset;
determining a network address of a licensor to transmit a second licensing request message from said licensing request server;
transmitting said second licensing request message from said licensing request server to said licensor wherein said second licensing request message comprises a cable service provider identifier, said digital asset identifier, and a correlation identifier;
receiving a first licensing response message at said licensing request server from said licensor, wherein said first licensing response message comprises said correlation identifier and a license for authorizing viewing of said digital asset at said set top box;
transmitting a second licensing response message at said licensing request server to said set top box, said licensing response message comprising said license wherein said license can only be used on said set top box; and
transmitting from said licensing request server to a billing system data comprising said set top box identifier or a subscriber profile identifier, said digital asset identifier, and an indication that a license was provided to the STB.

10. The method of processing according to claim 9 further comprising the step of:
testing the set top box identifier against a database of prohibited set top box identifiers to determine whether to perform the step of transmitting said second licensing request message to said licensor.

11. The method of claim 9 further comprising the step of:
using the subscriber profile to determine a credit status of the subscriber to determine whether to perform the step of transmitting said second licensing request to said licensor or response by sending a denial indication to the set top box.

12. The method of processing according to claim 9 wherein the determining a network address of a licensor is based on said network address of said licensor included in said first licensing request message.

13. The method of processing according to claim 9 wherein the step of determining a network address of a licensor is based on using the digital asset identifier to query a database wherein the response indicates the network address of the licensor.

14. The method of processing according to claim 9 wherein the first licensing request is stored in a log file in the licensing request server.

15. The method of processing according to claim 9 further comprising the step of:
generating a bill for a subscriber associated with the subscriber profile wherein said bill includes charges associated with receiving said license.

16. The method of processing according to claim 9 wherein the second licensing response message includes data indicating a limited number of times the digital asset can be viewed.

17. The method of processing according to claim 9 wherein the second licensing response message includes data indicating an expiration date associated with said license wherein said license is no longer effective after said expiration date for allowing viewing of the digital asset.

18. A method for providing a license to a set top box, comprising the steps of:
receiving at a server in a cable systems provider a first licensing response message from a content provider, said first licensing response message comprising a license associated with an identified digital asset, and a correlation identifier;
using the correlation identifier to retrieve first licensing request message stored in a memory of said server;
transmitting a second licensing response message to a set top box identified by a set top box identifier, wherein said set top box identifier is indicated in said first licensing request message;
storing an indication in a cable service billing system that said license was provided to said set top box, wherein said indication is linked with said set top box identifier; and
generating a bill for the subscriber wherein the bill includes a charge associated with the provision of the license to the set top box.

19. The method of claim 18 further wherein the second licensing response message comprises said license and data authorizing the set top box to view the digital asset a limited number of times, wherein further, said second licensing response message has a different format from said first licensing response message.

20. The method of claim 18 further comprising the step of:
receiving at the server a message from the set top box indicating a use of said license to view said digital asset.
